(19) United States
(12) Patent Application Publication
(10) Pub. No.: US 2007/0283395 A1
(43) Pub. Date: Dec. 6, 2007

(54) COMMUNICATION TERMINAL WITH SENDER-SPECIFIC ALERT SIGNALS

(75) Inventor: Martin Marcin, Robert WEZOWSKI, MALMO (SE)

Correspondence Address: ALBIHNS STOCKHOLM AB, BOX 5581, LINNEGATAN 2, SE-114 85 STOCKHOLM; SWEDENn, STOCKHOLM, omitted

(73) Assignee: SONY ERICSSON MOBILE COMMUNICATIONS AB, LUND (SE)

(21) Appl. No.: 11/421,491

(22) Filed: Jun. 1, 2006

(51) Int. Cl. H04N 7/173; H04N 7/18; H04N 7/16

(52) U.S. Cl. 725/81; 725/100; 725/131; 725/139; 725/8

(57) ABSTRACT

A radio communication terminal, and a method for alerting a communication terminal user of an incoming signal. The method comprises the steps of
receiving an input signal from a sender, such as a telephone call signal;
extracting identity data related to the sender, such as a telephone number extracted from the received signal or a name of the sender extracted from a memory in the terminal using the senders communication address;
generating and outputting an alert signal comprising a first audio part associated with the terminal and preferably used for all incoming phone calls, and a second audio part associated with the identity data, such that the alert signal provides an indication of who has sent the signal received in the terminal. The second audio part may be a modified version of the first audio part, or a separate audio piece such as its own audio file.

### FIELD OF THE INVENTION

The present invention relates to communication terminals and methods for use in such communication terminals for generating and outputting ring signals to alert a terminal user of an incoming call. More specifically, the invention relates to generating identity-specific ring signals which both identify the terminal from which the ring signal is emitted and the origin of the call.

### BACKGROUND

Telephony as such is a well established basic technology from many aspects. A first party makes use of a first telephone to dial a telephone number to a second telephone, thereby sending a call signal to the second terminal. When receiving the call signal, the second telephone emits an alert signal, or ring signal, in order to draw attention to the fact that an incoming call has been received. If someone picks up the second telephone, a speech conversation may be initiated.

Today, telephony as such includes not only traditional PSTN (Public Switched Telephone Network) communication, but also mobile telephony over radio communications systems such as GSM (Global System for Mobile Communications) or UMTS (Universal Mobile Telecommunications System), over satellite, and by means of IP telephony. The basic concept of providing an alert signal upon receiving an incoming call remains important, though. However, in modern type telephones, or communication terminals as they will be noted herein, there are often many more ways to produce an alert signal than by a ringing bell. Alternative means include buzzers and vibrators, and in recent years the use of so called polyphonic ring signals has been dominating the mobile phone industry. Today ring signals often include real audio files of music, speech, and various audio effects.

Mobile phones have also been presented on the market in which it is possible to assign dedicated ring signals linked to the identity of the caller. More specifically, the telephone number from which an incoming call is received, provided that the phone number has been sent with the call signal. This way, it may be possible for a user of the phone to grasp who has placed a call, without having to consult a display of the terminal where the identity of the caller is presented. Typically, a plurality of different contacts are stored in an electronic address book in the terminal, and a selectable ring signal may be assigned to any one of telephone numbers in the address book.

A problem with ring signals is associated with the fact that mobile phones have become so common, that in many countries they may be found in any mans hand. It is therefore not uncommon that many different users have configured their mobile phones to provide the same ring signals. When the phone is first purchased, the phone is generally preset to use a certain ring signal stored in a memory of the terminal, which ring signal is preset for all terminals of the same type or brand. There are often one or more auxiliary ring signals stored in the terminal, which the user selectively may change to, and it is also often possible to download ring signals from a network or from another mobile phone. Fact remains, though, that it is very common that you hear phones ringing which are erroneously assumed to be your own. This is probably partly due to the fact that many users find it cumbersome and time consuming to alter ring signals and download new ones, and partly due to the fact that certain ring signals tend to be very popular. Furthermore, it may be even more cumbersome to assign identity-specific ring signals to particular callers, to some extent due to the limited user interface of a compact mobile phone.

### SUMMARY OF THE INVENTION

A general object of the invention is therefore to provide a solution for designing and generating ring signals in communication terminals, in order to increase intelligibility to terminal users.

According to a first aspect, this object is fulfilled by a communication terminal, comprising:

a signal transceiver device configured to receive an input signal from a sender;
a data reading device configured to extract identity data related to the sender;
an alert signal generator, configured to generate an alert signal comprising
a first audio part associated with the terminal, and
a second audio part associated with the identity data;
   an audio output connected to the alert signal generator, configured to provide an alert signal comprising the first audio part and the second audio part to alert to a user of the terminal of an incoming input signal from the sender.

In one embodiment, the communication terminal is configured to sequentially repeat the first audio part and the second audio part.

In one embodiment the terminal comprises:
an audio player, wherein the second audio part includes a speech signal configured to identify the sender.

In one embodiment the identity data includes a communication address related to the sender, and wherein the generated audio signal includes the communication address.

In one embodiment the identity data is received with the input signal.

In one embodiment the received identity data includes audio data, and the alert signal generator is configured to generate the second audio part of an alert signal dependent on the received audio data.

In one embodiment the identity data includes a communication address related to the sender, and wherein the data reading device is configured to extract the communication address from the received input signal.

In one embodiment the terminal comprises:

an data memory configured to store information related to a plurality of communication addresses, wherein the data reading device is configured to extract auxiliary data related to the communication address from the data memory, and wherein the alert signal generator is configured to generate an alert signal with the second audio part configured dependent on the auxiliary data.

In one embodiment the terminal comprises:

an audio player, wherein the second audio part includes a speech signal configured to utter the auxiliary data.

In one embodiment the auxiliary data includes a name associated with the communication address.

In one embodiment the auxiliary data includes an audio file, and the alert signal generator is configured to generate an alert signal with the audio file as the second audio part.

In one embodiment the terminal comprises:

an audio player, wherein the second audio part includes a speech signal configured to utter a name associated with the sender.

In one embodiment the alert signal generator is configured to commonly generate the same first audio part without regard to the identity data of the sender.

In one embodiment the audio player is a speech synthesizer, wherein the second audio part includes a synthesized speech signal.

In one embodiment the audio player is connected to a memory holding audio files with recorded voice signals, wherein the second audio part includes a recorded voice signal.

In one embodiment the input signal is a call signal.

In one embodiment the input signal is a message signal.

According to a second aspect, the object stated above is fulfilled by a method for alerting a communication terminal user of an incoming signal, comprising the steps of:

receiving an input signal from a sender;
extracting identity data related to the sender;
generating an alert signal comprising
a first audio part associated with the terminal, and
a second audio part associated with the identity data; providing the alert signal to the user of the terminal.

In one embodiment the method comprises the steps of sequentially repeating the first audio part and the second audio part.

In one embodiment the method comprises the step of including a speech signal configured to identify the sender in the second audio part.

In one embodiment the identity data includes a communication address related to the sender, and wherein the generated audio signal includes the communication address.

In one embodiment the method comprises the step of receiving the identity data with the input signal.

In one embodiment the received identity data includes audio data, the method comprising the step of:
generating the second audio part of the alert signal dependent on the received audio data.

In one embodiment the identity data includes communication address related to the sender, the method comprising the step of:
extracting the communication address from the received input signal.

In one embodiment the method comprises the steps of:
storing information related to a plurality of communication addresses in a data memory;
extracting auxiliary data related to the communication address from the data memory; and
generating an alert signal with the second audio part including the auxiliary data.

In one embodiment the method comprises the step of:
uttering the auxiliary data by means of an audio player in the second audio part.

In one embodiment the auxiliary data includes a name associated with the communication address.

In one embodiment the auxiliary data includes an audio file, the method comprising the step of:

generating the alert signal with the audio file as the second audio part.

In one embodiment the auxiliary data comprises a name associated with the sender.

In one embodiment the method comprises the step of commonly generating the same first audio part without regard to the identity data of the sender.

In one embodiment the second audio part includes a synthesized speech signal.

In one embodiment the second audio part includes a recorded voice signal.

In one embodiment the input signal is a call signal.

In one embodiment the input signal is a message signal.

### BRIEF DESCRIPTION OF THE DRAWING

The features and advantages of the present invention will be more apparent from the following description of the preferred embodiments with reference to the accompanying drawings, on which

FIG. 1 schematically illustrates a system setup in which embodiments of the present inventive terminal and method are usable; and

FIG. 2 schematically illustrates functional blocks of a communication terminal embodiment of the present invention.

### DETAILED DESCRIPTION OF PREFERRED EMBODIMENTS

The present description relates to the field of communication terminals, configured to issue an alert signal responsive to receiving an incoming input signal, for the purpose of making a user of the terminal aware of the incoming signal. As such, the term communication terminal, also denoted terminal in short in this disclosure, includes all mobile equipment devised for radio communication with a radio station, which radio station also may be mobile terminal or e.g. a stationary base station. Furthermore, communication terminal also includes wire-connected terminals, such as standard PSTN telephones or DECT terminals (Digital Enhanced Cordless Telephony), or even IP telephones. In addition, it should be pointed out that the term communication terminal is not restricted to terminals configured for speech communication. Consequently, the term communication terminal may also include e.g. laptop computers, desktop computers and portable computers, configured to receive input signals in the form of data messages. In fact, regardless of whether the terminal is portable or not, and if the terminal is configured for speech communication or not, the concept of an input signal call may relate to both a call signal transmitted for the purpose of initiating a two way communication such as a telephone call or a chat session, and to a simple message transmitted one way, such as an email, sms, mms and so on. Furthermore, it should be emphasized that the term comprising or comprises, when used in this description and in the appended claims to indicate included features, elements or steps, is in no way to be interpreted as excluding the presence of other features elements or steps than those expressly stated.

Exemplary embodiments will now be described with references made to the accompanying drawings.

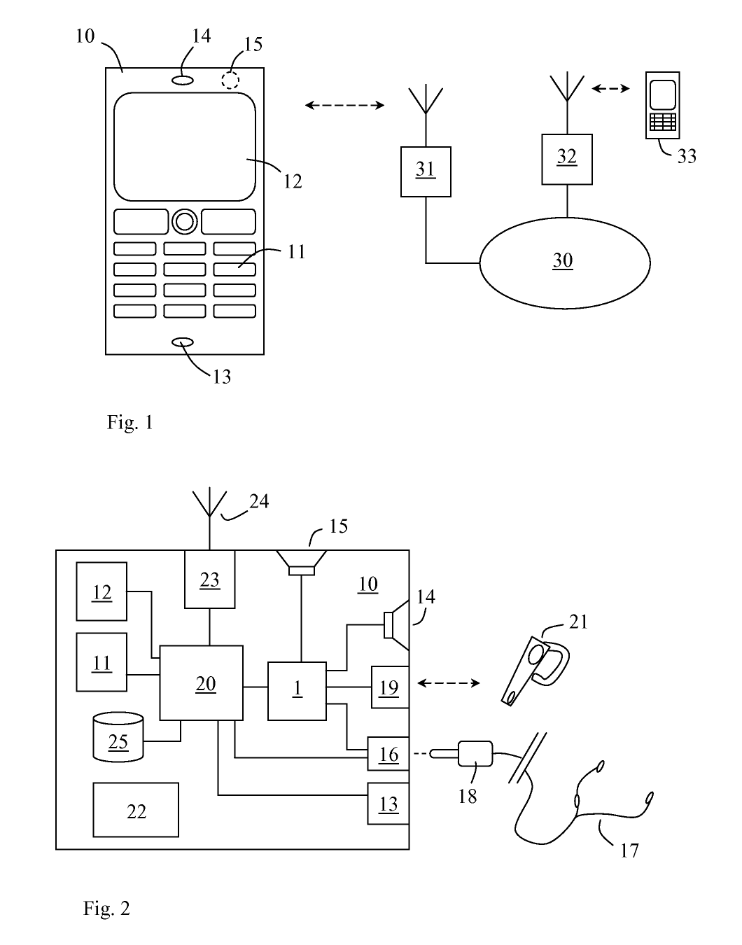

The invention will be described by means of an embodiment of a communication terminal in the form of a digital cellular radio communication terminal, or mobile phone, where FIG. 1 illustrates the outer appearance of a typical mobile phone for implementation of the invention, and FIG. 2 schematically illustrates functional features of the mobile phone by means of a block diagram. It should be noted that the elements indicated in FIG. 2 does not necessarily have to be physically divided in the manner shown, and that it is the functional relationship that is of primary interest. Furthermore, the outer appearance of the mobile phone need not take the indicated shape of FIG. 1, instead the mobile phone may e.g. be of a clamshell type, a jack knife type, or the like.

Terminal 10 is configured to operate in a radio communications network 30, by radio communication with a base station 31, or by direct radio communication with another terminal as a walkie-talkie. The terminal 10 includes a user interface comprising an input part 11, preferably including a set of keys, and additionally or optionally a touch-sensitive display. An output part 12 of the user interface includes a display 12 for presenting information to a terminal user. For the purpose of conducting speech communication, terminal 10 further preferably includes a microphone 13 and a speaker 14. As an alternative, terminal 10 may be devised with an audio interface in the form of connectors to an external microphone or speaker, as will be described with reference to FIG. 2. In FIG. 1, an additional alert signal speaker 15 is illustrated in phantom. In one embodiment the terminal 10 is configured to use speaker 14, i.e. the ear speaker, also to emit alert signals. A more common approach, though, is to employ another speaker 15 inter alia for that purpose, and reference will therefore be made to alert speaker 15 herein for the sake of simplicity.

FIG. 2 illustrates the terminal 10 in the form of a block diagram. A control unit 20 is indicated in FIG. 2, which represents a microprocessor system with associated memory space, operation software, and application software for handling internal processing such as signal processing, data encoding and decoding, and so on. The actual function of terminal 10 as a mobile phone is not crucial to the invention, and will therefore not be described in detail. As mentioned with reference to FIG. 1, the terminal 10 may include an audio interface may in the form of a connector 16 for connection to an external speaker, or a headset 17 including a speaker. The terminal further includes an audio output, preferably comprising an ear speaker 14 and possibly an additional alert signal speaker 15. In different embodiments the audio output additionally or optionally comprises connector 16 for connection of an external speaker, or headset 17. In one embodiment, connector 16 comprises a socket for connection to a plug 18 of headset 17, wherein the socket 16 preferably is configured to also receive audio signals from the headset 17 in the latter case. The audio output may also comprise a short range wireless transceiver unit 19, such as an IR interface or a Bluetooth chip, for wireless communication with a headset 21. In ordinary use of terminal 10 for telephone communication purposes, a user will speak into microphone 13 or a microphone of headset 17 or 21 for entering audio signals, which audio signals are processed and encoded to a radio signal by means of control device 20 in the terminal. The radio signal is subsequently transmitted to a remote party terminal by means of a radio transceiver unit 23 connected to an antenna 24. As a power supply, terminal 10 preferably further includes a battery 22. A data memory 25 is connected to control unit 20, and configured to store an electronic address book with information such as communication addresses and names for various contacts.

In accordance with the invention, terminal 10 is configured to provide alert signals to a user of the terminal. In FIG. 2 an alert signal generator is denoted 1, which is placed in communicative connection with the audio output, i.e. a built in speaker 14, 15 or a connector 16, 19 communicatively connectable to an external speaker 17, 21. In accordance with the invention, signal transceiver device 23 is configured to receive an input signal, such as a call signal or an sms, from a sender. The sender is illustrated in FIG. 1 as another mobile phone 33, communicatively connected to a base station 32 of network 30. However, the sender may just as well be a PSTN telephone communicatively connected to terminal 10 over network 30, or even a computer. In the case of telephony, the communication address of the sender 33, i.e. the telephone number, is transmitted along with the call signal to terminal 10, where it is received in signal transceiver 23. A data reading device in control unit 20 is configured to extract the communication address from the received input signal, and control unit 20 is typically configured to present the extracted communication address information on display 12. However, in addition to, or instead of, presenting the communication address on display 12, terminal 10 is configured to provide an audible alert signal adapted to reflect the identity of the sender terminal 10. Alert signal generator 1 is thereby configured to generate an alert signal comprising a first audio part associated with the terminal, and a second audio part associated with the identity data. The alert signal generator 1 passes the generated alert signal to the audio output, e.g. 15, to provide an audible alert signal comprising the first audio part and the second audio part to alert to a user of the terminal 10 of an incoming input signal from the sender.

The first audio part is consequently a signal which preferably is commonly used for all incoming calls, and which thereby identifies the receiving terminal 10. The first audio part is preferably selected by the user of terminal 10 from a range of different accessible alert signals in a memory 25 in terminal 10, or from an external source.

The second audio part is an audio signal which is specific to the sender as identified from the input signal received. It should be noted that the second audio part need not be unique to a single sender, even though it is related or linked to that sender. On the contrary, a certain second audio part may be used for e.g. all call signals or messages sent from a certain group. An example thereof could be to assign a certain second audio part to a signal received from any terminal of your workplace, such as any telephone number having a common set of initial figures.

By means of the invention a user of terminal 10 will be alerted that it is in fact his or her terminal that has received an input signal, as identified by the first audio part, and will further be provided with an indication of the identity of the person or authority calling, by means of the second audio part. In one embodiment the communication terminal is configured to sequentially repeat the first audio part and the second audio part, if the user of terminal 10 does not respond to or act on the input signal. Furthermore, in a preferred embodiment the first audio part is outputted as the very first part of the alert signal, before the second audio part is first emitted. However, it may very well be the other way around in an alternative embodiment, namely that the second audio part is emitted as the very first signal in the alert signal. In this context, first audio part and second audio part therefore does not specifically identify their order of emission in the complex alert signal.

The manner in which to emit the alert signal may vary in different embodiments. In one embodiment the first audio part is a melodic piece or other significant mark for the user to be able to recognize his or her phone. However, the melody or e.g. the pitch can then be varied depending on the identity of the sender, wherein the modified part of the alert signal constitutes the second audio part. The modification of the audio signal used as the first audio part, into the second audio part, can be generated from control data stored in an address book held in memory 25. In the address book of memory 25 the control data stored for a certain contact is linked to the communication address of that contact, which communication address is extractable from the received input signal. So, once the communication address of the sender has been extracted from the received input signal, the data reading device of control unit 1 is configured to extract auxiliary data from the memory 25 associated with that communication address, and control alert signal generator to produce the second audio part of the alert signal dependent on the auxiliary data. In this case, the auxiliary data is control data determining how to modify the basic alert signal used as the first audio part. Alternatively, the auxiliary data may in fact comprise data which is included in the second audio part. In such an embodiment the auxiliary data may e.g. be a separate audio file to be played after or before the first audio part. In such a case, alert signal generator 1 comprises a media player, such as an mp3 player.

In one embodiment, at least the second audio part is generated in the form of a speech signal, configured to utter identity data identifying the sender. In a first variant of this embodiment, the speech signal is configured to utter the communication address as received with the input signal. Such an embodiment does not require any identity data to be pre-stored for the sender in memory 25. Assume that the sender has initiated a telephone call from a telephone 33 with phone number 123456, which number is received in the input signal by transceiver unit 23 of terminal 10. The phone number is extracted by the data reading device of control unit 20, and fed to the alert signal generator 1. A pre-stored first audio part for use in the alert signal is fetched as an audio file from memory 25 Alternatively, control data for generating the first audio part by means of alert signal generator 1 is fetched from memory 25. In this example the first audio part is “ring ring ring”. Alert signal generator 1 then generates the alert signal, which is passed to the audio output to be used, such as built in speaker 15, or e.g. to connector 16 if headset 17 is connected. The alert signal played out will then be:
“ring ring ring”—“123456”—“ring ring ring” . . .
   where the figures 123456 are actually spelled out by a voice. The voice may either be composed of separate voice recordings of a true voice, or a synthesized speech signal.

In an embodiment where auxiliary data is stored linked to the communication address in memory 25, control unit 1 may be configured to extract that auxiliary data and send it to the alert signal generator 1. Again, the auxiliary data may be control data or an audio file. As an example the content of the auxiliary data may comprise a name of the sender. The alert signal played may then be:
“ring ring ring”—“Heidi Bloom”—“ring ring ring” . . .
   A variant of this is to also include a predetermined voice sequence for intelligibility reasons, such that the alert signal is played as:
“ring ring ring”—“Heidi Bloom is calling””—“ring ring ring”
   where the underlined speech signal is pre-stored and used for all senders.

For messages, as opposed to telephone call signals, a separate first audio part is preferably used, such as “beep beep”. The corresponding complex alert signal could then be:
“beep beep”—“You have a message from Heidi Bloom”—“beep beep” . . . ,
   where again the underlined speech signal portion is a pre-stored default speech signal.

The embodiments outlined above are based on the fact that the received input signal includes identity data, which in one way or another represents the sender. It should be noted that identity data is not the same as identity, i.e. it need not be a name. Typically, and as described in the embodiments above, the identity data is or includes the communication address from which the signal originates, such as a telephone number, an IP address, or an email address. In one embodiment, the input signal received by transceiver unit 23 may include identity data comprising audio data. The audio data may be an audio file, e.g. an mp3 file, or it may include control data for the alert signal generator 1. In any case, alert signal generator 1 is configured to generate the second audio part of an alert signal dependent on the received audio data, when the audio data has been extracted from the received signal by the data reading device of control unit 1. Such an embodiment allows for sending parties to at least partly define by themselves, what the alert signal will sound like in a terminal 10, when they call or send a message to that terminal 10 from their own terminal 33. Such an embodiment requires that terminal 10 is configured to allow receipt and usage of such audio data. As a variant to that embodiment, the audio data included in the received signal is not used for generating the alert signal when the signal is received. However, the user will be prompted on the display 12 to indicate whether or not the received audio data is to be stored in memory 25 linked to the sender in question, for future use as a second audio part of an alert signal, when that sender calls or sends a message. Preferably, the user may also choose to listen to an alert signal generated dependent on the received audio data, before approving it to be stored and used.

Besides the terminal as such, the invention relates to a method for alerting a communication terminal user of an incoming signal, which method comprises the steps of:
1. Receiving an input signal from a sender. The input signal may e.g. be a call signal from a caller, or a message from a messenger.
2. Extracting identity data related to the sender. The identity data may be a communication address, e.g. a telephone number, which is extracted from the received signal. Alternatively, the identity data may be auxiliary data, e.g. a name of the sender, extracted from a memory in the terminal using the extracted communication address. The identity data may also be a data file received with the signal.
3. Generating an alert signal comprising a first audio part associated with the terminal, and a second audio part associated with the identity data. The first audio part is preferably used for all incoming signals of a certain type, i.e. typically one signal for telephone calls and another signal for sms. The second audio part may be a modified version of the first audio part, e.g. by changing melody or pitch, or by adding effects to the audio signal as represented by the first audio part. As an alternative, the second audio part may be a separate audio piece, such as its own audio file. The second audio part may also be generated as a speech signal, pre-recorded or synthesized, configured to utter words included in the identity data, such as a communication address or a name related to the sender.
4. Providing the alert signal to the user of the terminal. This is achieved using some form of transducer, such as a built in speaker 15 or, if a headset 17, 21 is temporarily connected, to a speaker of the headset.

A benefit with the invention is that the user will be better informed that with state of the art solutions, when an incoming signal is received. The first audio part will alert the user that it is in fact his or her terminal that has received a message. This is advantageous due to the vast use of mobile phones in particular. The second audio part gives the user a hint of who actually sent the signal now received, without having to consult the display.

The principles of the present invention have been described in the foregoing by examples of embodiments or modes of operations. However, the invention should not be construed as being limited to the particular embodiments discussed above, which are to be regarded as illustrative rather than restrictive, and it should be appreciated that variations may be made in those embodiments by persons skilled in the art, without departing from the scope of the present invention as defined by the appended claims.

I claim:

1. A communication terminal, comprising:
a signal transceiver device configured to receive an input signal from a sender;
a data reading device configured to extract identity data related to the sender;
an alert signal generator, configured to generate an alert signal comprising
a first audio part associated with the terminal, and
a second audio part associated with the identity data;
an audio output connected to the alert signal generator, configured to provide an alert signal comprising the first audio part and the second audio part to alert to a user of the terminal of an incoming input signal from the sender.

2. The communication terminal of claim 1, configured to sequentially repeat the first audio part and the second audio part.

3. The terminal of claim 1, comprising:
an audio player, wherein the second audio part includes a speech signal configured to identify the sender.

4. The terminal of claim 1, wherein the identity data includes a communication address related to the sender, and wherein the generated audio signal includes the communication address.

5. The terminal of claim 1, wherein the identity data is received with the input signal.

6. The terminal of claim 5, wherein the received identity data includes audio data, and the alert signal generator is configured to generate the second audio part of an alert signal dependent on the received audio data.

7. The terminal of claim 1, wherein the identity data includes a communication address related to the sender, and wherein the data reading device is configured to extract the communication address from the received input signal.

8. The terminal of claim 7, comprising:
an data memory configured to store information related to a plurality of communication addresses, wherein the data reading device is configured to extract auxiliary data related to the communication address from the data memory, and wherein the alert signal generator is configured to generate an alert signal with the second audio part configured dependent on the auxiliary data.

9. The terminal of claim 8, comprising:
an audio player, wherein the second audio part includes a speech signal configured to utter the auxiliary data.

10. The terminal of claim 8, wherein the auxiliary data includes a name associated with the communication address.

11. The terminal of claim 8, wherein the auxiliary data includes an audio file, and the alert signal generator is configured to generate an alert signal with the audio file as the second audio part.

12. The terminal of claim 1, comprising:
an audio player, wherein the second audio part includes a speech signal configured to utter a name associated with the sender.

13. The terminal of claim 1, wherein the alert signal generator is configured to commonly generate the same first audio part without regard to the identity data of the sender.

14. The terminal of claim 3, wherein the audio player is a speech synthesizer, wherein the second audio part includes a synthesized speech signal.

15. The terminal of claim 3, wherein the audio player is connected to a memory holding audio files with recorded voice signals, wherein the second audio part includes a recorded voice signal.

16. The terminal of claim 1, wherein the input signal is a call signal.

17. The terminal of claim 1, wherein the input signal is a message signal.

18. A method for alerting a communication terminal user of an incoming signal, comprising the steps of:
receiving an input signal from a sender;
extracting identity data related to the sender;
generating an alert signal comprising
a first audio part associated with the terminal, and
a second audio part associated with the identity data;
providing the alert signal to the user of the terminal.

19. The method of claim 18, comprising the steps of sequentially repeating the first audio part and the second audio part.

20. The method of claim 18, comprising the step of including a speech signal configured to identify the sender in the second audio part.

21. The method of claim 18, wherein the identity data includes a communication address related to the sender, and wherein the generated audio signal includes the communication address.

22. The method of claim 18, comprising the step of receiving the identity data with the input signal.

23. The method of claim 22, wherein the received identity data includes audio data, comprising the step of:
generating the second audio part of the alert signal dependent on the received audio data.

24. The method of claim 18, wherein the identity data includes communication address related to the sender, comprising the step of:
extracting the communication address from the received input signal.

25. The method of claim 24, comprising the steps of:
storing information related to a plurality of communication addresses in a data memory;
extracting auxiliary data related to the communication address from the data memory; and
generating an alert signal with the second audio part including the auxiliary data.

26. The method of claim 25, comprising the step of:
uttering the auxiliary data by means of an audio player in the second audio part.

27. The method of claim 26, wherein the auxiliary data includes a name associated with the communication address.

28. The method of claim 25, wherein the auxiliary data includes an audio file, comprising the step of:
generating the alert signal with the audio file as the second audio part.

29. The method of claim 26, wherein the auxiliary data comprises a name associated with the sender.

30. The method of claim 18, comprising the step of commonly generating the same first audio part without regard to the identity data of the sender.

31. The method of claim 18, wherein the second audio part includes a synthesized speech signal.

32. The method of claim 18, wherein the second audio part includes a recorded voice signal.

33. The method of claim 18, wherein the input signal is a call signal.

34. The method of claim 18, wherein the input signal is a message signal.
